(19) United States
(12) Patent Application Publication
(10) Pub. No.: US 2011/0266380 A1
(43) Pub. Date: Nov. 3, 2011

(54) Dropped Charge Protection System and a Monitoring System

(76) Inventor: Paul Hendrik Stephanus Van Zyl, Kempton Park (ZA)

(21) Appl. No.: 13/126,853

(22) PCT Filed: Oct. 30, 2009
(86) PCT No.: PCT/IB09/54820

§ 371 Date: Jul. 18, 2011

(30) Foreign Application Priority Data
Oct. 30, 2008 (ZA) 2008/09300

(51) Int. Cl. B02C 25/00

(52) U.S. Cl. 241/36

(57) ABSTRACT

The invention provides for a dropped charge protection system, wherein the system includes calculating an angle of repose of a charge of a grinding mill during start-up and tripping the mill motor when the angle of repose of the charge exceeds a maximum allowable angle. The invention also provides for a control system for controlling the torque applied to starting a grinding mill, wherein the system includes using a pre-determined angle of repose, controlling a real angle of repose of a charge such that the real angle of repose coincides with the pre-determined angle of repose through the manipulation of the torque of the motor and wherein the angle of repose is controlled in such a way as to encourage tumbling of the charge.

### FIELD OF THE INVENTION

The invention is in the field of systems that are used to monitor and protect mills from damage caused by dropped charges.

### BACKGROUND TO THE INVENTION

The inventor is aware of the potential damage that may be caused to a mill when a charge becomes solidified or semi-solidified and drops as a solid mass instead of tumbling through the rotation of the drum. The dropped charge (also known as a frozen/baked/locked or cemented charge) consists of the mined ore, water and grinding balls and may cause damage to the drum and/or the drive.

Damage to the drive and/or the drum leads to down time of the mill and production loss.

Electronic systems that protect gearless mill drives (GMD) from dropped charges are known. GMD are however significantly more expensive than geared mills. The potential damage to a geared drive by a dropped charge may be a contributing factor for mines opting for a GMD despite the high capital outlay.

Moreover, mechanical systems that prevent dropped charges in geared mills are known. These are however relatively costly and are generally thought to be ineffective.

The inventor believes that a need exists for a dropped charge protection system that can be used effectively in a geared mill arrangement.

### SUMMARY OF THE INVENTION

Definitions for purpose of interpreting this specification:

The angle of repose is defined for the purpose of this invention as the angle between the vector from the mill's axis of rotation to the centre of gravity of the charge and the gravitational vector.

According to an aspect of the invention there is provided a dropped charge protection system, wherein the system includes calculating an angle of repose of a charge of a grinding mill during start-up and tripping the mill motor when the angle of repose of the charge exceeds a maximum allowable angle.

The dropped charge protection system may include plotting the calculated angle of repose relative an angle of rotation of the mill shell.

The angle of repose of the charge may be determined by solving the non-linear differential equation of T=Jα+mgr sin θ, wherein

T is the air-gap torque applied to the motor rotor by the electric field;

α is the angular acceleration of the mill around the centre of rotation of the mill shell and may be determined from d/dt(ω). ω is the angular speed of the mill shell around the centre of rotation of the mill shell and may be determined from d/dt(φ);

J is the moment of inertia [kgm²] of all the rotating mass referenced to the mill shell side of the drive train;

m is the mass of the charge;

g is the gravitational constant;

r is the radius from the mill shell's axis of rotation to the centre of gravity of the charge; and θ is the rotation of the centre of gravity of the charge around the mill shell's axis of rotation which was defined above as the angle of repose. Before the charge has tumbled, it rotates with the mill shell and θ=φ, and wherein φ is the angular position of the mill shell around the centre of rotation of the mill shell;

The torque T may cause the acceleration of all rotating masses (Jα), and, the pendulum-like raising of the charge (mgr sin θ)

It is to be appreciated from this specification that the tripping criterion in the equation T=Jα+mgr sin θ is the angle of repose (θ). In order to solve θ, the system parameters J and mgr must be determined and the system variables T and α measured in real time or calculated from measurable quantities in real time.

The torque (T) may be calculated using the formula T=P/ω wherein P is the power of the motor and ω is the angular speed of the motor.

Any one or more of θ and/or α and/or ω may be measured through the use of rotary encoders, magnetic pick-ups and the like on the motor shaft or elsewhere in the drive train.

T and any one or more of φ and/or α and/or ω may be calculated from the rotor current of the mill motor in real time, making both the instantaneous measurement of P and the use of rotary encoders, magnetic pick-ups and the like on the motor shaft or elsewhere in the drive train unnecessary in the case of a wound-rotor motor if the rotor current is accessible.

The torque (T) produced by the wound-rotor motor may be directly proportional to the rotor current.

The mill motor may include a liquid resistance starter (LRS) in series with the motor rotor windings.

The LRS may control the rotor current and thereby control the amount of torque produced by the motor as the torque may be proportional to the rotor current.

The power factor (the ratio of the real power to the apparent power,) in the rotor circuit may be close to unity (where unity=1) and the torque may therefore be determined by the formula T=(I/I_{rated})T_{rated} wherein T is the air-gap Torque or T_{airgap}, I is the rotor current and I_{rated} is the rated rotor current at rated torque, produced at rated power.

α may be determined from ω by differentiation (d/dt(ω))

The mill rotation speed (ω) may be determined from the motor speed (n) and the gear ratio.

The motor speed (n) may be calculated from the rotor current using the formula

$$n = \frac{{f}_{system} - {f}_{rotor}}{p} \times 60 [ rpm ] ,$$

wherein f_{system} is the frequency of the system (line frequency), fᵣₒₜₒᵣ is the frequency of the rotor current of the motor, and p is the number of pole pairs of the motor.

The frequency of the rotor current of the motor (fᵣₒₜₒᵣ) may be determined rotor, by inverting the period of a measured sine wave cycle of the rotor current.

The moment of inertia of all rotating mass (J), the mass of the charge (m) and the radius from the centre of the mill's axis of rotation to the centre of gravity of the charge (r) may be unknown.

J and mgr may be dependent on r but r may not be readily determinable due to the non-homogenous state of the charge.

J and mgr may be determined dynamically within the first few degrees of mill rotation, before the possibility of a dropped charge exists, so that the system can start calculating θ timeously.

It is to be appreciated from this specification that φ must be determined if it is to be used in the calculation of J and mgr. In the period before tumbling it is known that θ=φ and θ is therefore known.

The mill shell's rotation φ may also be determined by integration of ω where the integration of ω is the taking the integral of ω with respect to time.

At a small mill shell rotation of 1°, φ=θ=1° and sin(1°)=0.017 and the contribution of mgr sin θ to T=Jα+mgr sin θ may be relatively small resulting in T=Jα+mgr sin θ being simplified to T=Jα and J may therefore be calculated from the formula

$$J = \frac{T}{α} .$$

It is however to be appreciated from this specification that although φ=1° was used, the result holds for any angle of φ=θ small enough that mgr sin θ can be neglected from T=Jα+mgr sin θ.

At a relatively bigger mill shell rotation, of φ=10°, the charge may not have yet rotated enough to tumble, but sin(10°)=0.173 and the contribution of mgr sin θ is therefore 10 times bigger in the equation T=Jα+mgr sin θ and can no longer be neglected.

mgr may therefore be calculated from the equation

$$mgr = \frac{T - J α}{sin ( 10 ° )}$$

as both the mill and the angle of repose are 10°.

It is once again to be appreciated from the specification that the calculation is not limited to φ=10°. The result will hold for any angle of φ=θ wherein said angle is large enough that mgr sin θ can not be neglected from T=Jα+mgr sin θ, but small enough that the charge has not yet tumbled.

As soon as J and mgr have been calculated, it is possible to calculate θ, plot θ relative an angle of rotation of the mill shell (φ) and trip the mill motor when the angle of repose of the charge exceeds a maximum allowable angle.

Tumbling may have occurred when φ is no longer equal to θ, and this may be used as a criterion to determine if start-up of the mill has been safe and successful. The dropped charge protection system may continue to record the rotor current after tumbling and facilitate evaluation of the rotor current and resultant torque

According to another aspect of the invention there is provided a control system controlling the torque applied to starting a grinding mill, wherein the system includes using a pre-determined angle of repose, controlling a real angle of repose of a charge such that the real angle of repose coincides with the pre-determined angle of repose through the manipulation of the torque of the motor and wherein the angle of repose is controlled in such a way as to encourage tumbling of the charge.

The torque may be the actuating signal and the angle of repose θ may be the controlled signal.

The angle of repose of the charge may be determined by solving the non-linear differential equation of T=Jα+mgr sin θ, wherein

T is the air-gap torque applied to the motor rotor by the electric field;

α is the angular acceleration of the mill around the centre of rotation of the mill and may be determined from d/dt(ω). ω is the angular speed of the mill shell around the centre of rotation of the mill shell and may be determined from d/dt(φ);

J is the moment of inertia [kgm²] of all the rotating mass referenced to the mill side of the drive train;

m is the mass of the charge;

g is the gravitational constant;

r is the radius from the mill's axis of rotation to the centre of gravity of the charge; and

θ is the rotation of the centre of gravity of the charge around the mill's axis of rotation which was defined above as the angle of repose. Before the charge has tumbled, it rotates with the mill and θ=φ, and wherein φ is the angular position of the mill around the centre of rotation of the mill shell;

The torque T may effect the acceleration of all rotating masses (Jα), and, the pendulum-like raising of the charge (mgr sin θ)

It is to be appreciated from this specification that the controlled variable in the equation T=Jα+mgr sin θ is the angle of repose (θ). In order to solve θ, the system parameters J and mgr must be determined and the system variables T and α measured in real time or calculated from measurable quantities in real time.

The torque (T) may be calculated using the formula T=P/ω wherein P is the power of the motor and ω is the angular speed of the motor.

Any one or more of θ and/or α and/or ω may be measured through the use of rotary encoders, magnetic pick-ups and the like on the motor shaft or elsewhere in the drive train.

T and any one or more of φ and/or α and/or ω may be calculated from the rotor current of the mill motor in real time, making both the instantaneous measurement of P and the use of rotary encoders, magnetic pick-ups and the like on the motor shaft or elsewhere in the drive train unnecessary in the case of a wound-rotor motor as the rotor current is accessible.

The torque (T) produced by the wound-rotor motor may be directly proportional to the rotor current.

The mill motor may include a liquid resistance starter (LRS) in series with the motor rotor windings.

The LRS may control the rotor current and thereby control the amount of torque produced by the motor as the torque is proportional to the rotor current.

The power factor (the ratio of the real power to the apparent power,) in the rotor circuit may be close to unity (where unity=1) and the torque may therefore be determined by the formula T=(I/I_{rated})T_{rated} wherein T is the air-gap Torque or T_{airgap}, I is the rotor current and I_{rated} is the rated rotor current at rated torque, produced at rated power.

α may be determined from ω by differentiation (d/dt(ω))

The mill rotation speed (ω) may be determined from the motor speed (n) and the gear ratio.

The motor speed (n) may be calculated from the rotor current using the formula

$$n = \frac{{f}_{system} - {f}_{rotor}}{p} \times 60 [ rpm ] ,$$

wherein f_{system} is the frequency of the system (line frequency), fᵣₒₜₒᵣ is the frequency of the rotor current of the motor, and p is the number of pole pairs of the motor.

The frequency of the rotor current of the motor (fᵣₒₜₒᵣ) may be determined rotor, by inverting the period of a measured sine wave cycle of the rotor current.

The moment of inertia of all rotating mass (J), the mass of the charge (m) and the radius from the centre of the mill's axis of rotation to the centre of gravity of the charge (r) may be unknown.

J and mgr may be dependent on r but r may not be readily determinable due to the non-homogenous state of the charge.

J and mgr may be determined dynamically within the first few degrees of mill rotation, before the possibility of a dropped charge exists, so that the system can start calculating θ timeously.

It is to be appreciated from this specification that φ must be determined if it is to be used in the calculation of J and mgr. In the period before tumbling it is known that θ=φ and θ is therefore known.

The mill shell's rotation φ may also be determined by integration of ω where the integration of ω is the taking the integral of ω with respect to time.

At a small mill shell rotation of 1°, φ=θ=1° and sin(1°)=0.017 and the contribution of mgr sin θ to T=Jα+mgr sin θ may be relatively small resulting in T=Jα+mgr sin θ being simplified to T=Jα and J may therefore be calculated from the formula

$$J = \frac{T}{α} .$$

It is however to be appreciated from this specification that although φ=1° was used, the result holds for any angle of φ=θ small enough that mgr sin θ can be neglected from T=Jα+mgr sin θ.

At a relatively bigger mill shell rotation, of φ=10°, the charge may not have yet rotated enough to tumble, but sin(10°)=0.173 and the contribution of mgr sin θ is therefore 10 times bigger in the equation T=Jα+mgr sin θ and can no longer be neglected.

mgr may therefore be calculated from the equation

$$mgr = \frac{T - J α}{sin ( 10 ° )}$$

as both the mill and the angle or repose are 10°.

It is once again to be appreciated from the specification that the calculation is not limited to φ=10°. The result will hold for any angle of φ=θ wherein said angle is large enough that mgr sin θ can not be neglected from T=Jα+mgr sin θ, but small enough that the charge has not yet tumbled.

As soon as mgr have been calculated, it is possible to calculate the amount of torque (T) necessary to keep φ at an optimum angle for the charge to tumble. By controlling the liquid resistance starter, the rotor current can be controlled to apply the correct amount of torque to bring φ to this optimum angle.

Unrelated to the issue of dropped charge, another advantage of this system is that with a small additional software algorithm and no additional hardware cost, the rotor current and therefore torque can be controlled such as to eliminate overtorque transients and arcing of the LRS electrodes, which is a common problem with present generation LRSs.

The inventor believes that the invention has the advantage of providing a reliable and satisfactory dropped charge protection system for geared mills that are driven by wound rotor induction motors. Thereafter, the current is still recorded, and from this the engineer/operator is able to evaluate the rotor current and therefore the torque.

Furthermore, the inventor believes that the system provides an accurate evaluation of the liquid resistance starter performance and allows for control of the LRS and the resultant rotor current and therefore the torque of the motor. Over-torque transients will be caused if the LRS decreases its resistance too rapidly during start-up of the motor, causing the current of the motor to increase too rapidly, with a resultant undesirable high torque.

### EXAMPLE AND DETAILED DESCRIPTION OF DRAWINGS

The invention will be further explained by way of the following non-limiting working example and drawings of a dropped charge protection relay and monitoring system, wherein

FIG. 1 shows the start-up graphs of a grinding mill in accordance with the invention; and

FIG. 2 is a screen shot of a Human Machine Interface that depicts a graph of the charge's angle of repose (θ) relative the mill shell angle of rotation (φ). The screenshot also shows a graphic representation of the θ and φ in a simulated mill shell.

A dropped charge protection relay system, wherein the system calculates an angle of repose of a charge of a grinding mill during start-up, plots the angle of repose of the charge relative an angle of rotation of the mill and trips the mill motor when the angle of repose of the charge exceeds a maximum allowable angle.

Measurements and certain calculated values are recorded at a sampling rate of 1 kHz for the duration of the mill start-up.

The angle of repose of the charge is determined by solving the non-linear differential equation of T=Jα+mgr sin θ, wherein

T is the air-gap torque applied to the motor rotor by the electric field;

α is the angular acceleration of the mill around the centre of rotation of the mill shell and may be determined from d/dt(ω) and wherein ω is the angular speed of the mill around the centre of rotation of the mill and may be determined from d/dt(φ);

J is the moment of inertia [kgm²] of all the rotating mass referenced to the mill side of the drive train;

m is the mass of the charge;

g is the gravitational constant;

r is the radius from the mill's axis of rotation to the centre of gravity of the charge; and

θ is the rotation of the centre of gravity of the charge around the mill's axis of rotation which was defined above as the angle of repose. Before the charge has tumbled, it rotates with the mill and θ=φ and wherein φ is the angular position of the mill shell around the centre of rotation of the mill shell;

The torque T causes the acceleration of all rotating masses (Jα), and, the pendulum-like raising of the charge (mgr sin θ)

The tripping criterion in the equation T=Jα+mgr sin θ is the angle of repose (θ). In order to solve θ, the system parameters J and mgr must be determined and the system variables T and α measured in real time or calculated from measurable quantities in real time.

In this example the torque (T) is not calculated using the formula T=P/ω wherein P is the power of the motor and ω is the angular speed of the motor.

It is to be appreciated from this specification that any one or more of θ and/or a and/or ω can be measured through the use of rotary encoders, magnetic pick-ups and the like on the motor shaft or elsewhere in the drive train, but neither is this done in the example.

As a matter of fact, in this example, T, φ a, α and ω are calculated from the rotor current of the mill motor in real time, making both the instantaneous measurement of P and the use of rotary encoders, magnetic pick-ups and the like on the motor shaft or elsewhere in the drive train unnecessary in the case of a wound-rotor motor as the rotor current is accessible.

As the mill's motor rotor circuit includes a liquid resistance starter (LRS) in series with the motor rotor windings during start-up, the power factor of the rotor circuit is close to unity (=1), and therefore the torque (T) produced by the wound rotor motor is directly proportional to the rotor current.

The power factor (the ratio of the real power to the apparent power,) in the rotor circuit is close to unity (where unity=1) and the torque is therefore determinable by the formula T=(I/I_{rated})T_{rated} wherein T is the air-gap Torque or T_{airgap}, I is the rotor current and I_{rated} is the rated rotor current at rated torque, produced at rated power.

In this working example of the invention, a is determined from ω by differentiation (d/dt(ω)) and the mill rotation speed (ω) is determined from the motor speed (n) and the gear ratio.

The motor speed (n) is calculated from the rotor current using the formula

$$n = \frac{{f}_{system} - {f}_{rotor}}{p} \times 60 [ rpm ] ,$$

wherein f_{system} is the frequency of the system (line frequency), fᵣₒₜₒᵣ is the frequency of the rotor current of the motor, and p is the number of pole pairs of the motor. (In the case of a 6 pole motor, p=3 and in the case of an 8 pole motor p=4.)

The frequency of the rotor current of the motor (fᵣₒₜₒᵣ) is determined by rotor, is inverting the period of a measured sin θ wave cycle of the rotor current.

The moment of inertia of all rotating mass (J), the mass of the charge (m) and the radius from the centre of the mill's axis of rotation to the centre of gravity of the charge (r) are unknown at the moment of start-up.

J and mgr are dependent on r but r may not be readily determinable due to the non-homogenous state of the charge.

J and mgr are therefore determined dynamically within the first few degrees of mill rotation, before the possibility of a dropped charge exists, so that the system can start calculating θ timeously.

Furthermore, φ must be determined if it is to be used in the calculation of J and mgr. In the period before tumbling it is known that θ=φ and θ is therefore known.

The mill rotation φ is determined through the integration of ω where the integration of ω is the taking the integral of ω with respect to time.

At a small mill shell rotation of 1°, φ=θ=1° and sin(1°)=0.017 and the contribution of mgr sin θ to T=Jα+mgr sin θ is relatively small resulting in T=Jα+mgr sin θ being simplified to T=Jα and J is therefore be calculated from the formula

$$J = \frac{T}{α} .$$

This example determines J at φ=θ=1°.

It is however to be appreciated from this specification that although φ=1° was used, the result holds for any angle of φ=θ small enough that mgr sin θ can be neglected from T=Jα+mgr sin θ.

At a relatively bigger mill shell rotation, of φ=10°, the charge has not yet rotated enough to tumble, but sin(10°)=0.173 and the contribution of mgr sin θ is therefore 10 times bigger in the equation T=Jα+mgr sin θ and can no longer be neglected.

mgr is therefore calculated from the equation

$$mgr = \frac{T - J α}{sin ( 10 ° )}$$

as both the angle of rotation of the mill shell φ and the angle of repose θ are 10°, in this example.

It is once again to be appreciated from the specification that the calculation is not limited to φ=10°. The result will hold for any angle of φ=θ wherein said angle is large enough that mgr sin θ can not be neglected from T=Jα+mgr sin θ, but small enough that the charge has not yet tumbled.

As soon as J and mgr have been calculated, it is possible to calculate θ, plot θ relative an angle of rotation of the mill shell (φ) and trip the mill motor when the angle of repose of the charge exceeds a maximum allowable θ value.

It is however to be appreciated from this specification that the invention also allows for the control the angle of rotation of the mill shell φ. to facilitate tumbling of the charge.

It is also to be appreciated from this specification that the invention also allows for the control of the torque of the motor until the motor is at full speed. Controlling the torque of the motor minimizes the risk of over-torque transients and mechanical failure.

Over-torque can occur at any time that the LRS is not presenting enough resistance to the rotor circuit to limit the rotor current (and therefore torque) to a safe value, even at the moment the motor is switched on. Typically, in order to evaluate the risk of torque transients, the engineer/operator would study the value of the rotor current during the entire start-up.

The following table shows the various measured and calculated values during the start-up of a grinding mill.

Values at start-up:

| [ms] | Ir1 | Iw1 | Ib1 | Vpp1 | Ir2 | Iw2 | Ib2 | Vpp2 | T | n | \|I\| |
|---|---|---|---|---|---|---|---|---|---|---|---|
| 00000 | −0.739 | −17.582 | −0.192 | 5.119 | −16.666 | 19.619 | 31.845 | −1.551 | 20.000 | 0.000 | 0.000 |
| 00001 | −1.057 | −18.530 | 0.446 | 1.958 | −19.531 | 18.039 | 32.164 | −1.235 | 20.000 | 0.000 | 0.000 |
| 00002 | −0.420 | −18.214 | 0.127 | 2.274 | −19.850 | 17.723 | 32.483 | −1.551 | 20.000 | 0.000 | 0.000 |
| 00003 | −1.057 | −16.950 | 0.127 | 1.010 | −21.442 | 17.092 | 32.483 | −1.867 | 20.000 | 0.000 | 0.000 |
| 00004 | −1.057 | −16.318 | −0.192 | −2.467 | −24.943 | 17.092 | 33.758 | −1.235 | 20.000 | 0.000 | 0.000 |
| 00005 | −0.420 | −16.002 | −0.192 | −2.783 | −25.262 | 15.828 | 33.439 | −1.235 | 20.000 | 0.000 | 0.000 |
| 00006 | −0.420 | −16.318 | −0.192 | −2.151 | −24.307 | 15.512 | 33.120 | −1.235 | 20.000 | 0.000 | 0.000 |
| 00007 | −0.420 | −16.634 | 0.446 | −1.835 | −23.670 | 15.828 | 31.845 | −1.867 | 20.000 | 0.000 | 0.000 |
| 00008 | −0.420 | −16.634 | 0.446 | −1.519 | −23.670 | 14.565 | 31.526 | −2.815 | 20.000 | 0.000 | 0.000 |
| 00009 | 0.854 | −16.318 | −0.829 | −1.203 | −25.262 | 14.880 | 31.207 | −1.235 | 20.000 | 0.000 | 0.000 |
| 00010 | −3.924 | −17.266 | 0.127 | −0.571 | −23.033 | 15.196 | 31.845 | −2.183 | 20.000 | 0.000 | 0.000 |
| 00011 | 0.854 | −17.266 | −0.192 | 1.010 | −20.805 | 15.828 | 31.526 | −1.551 | 20.000 | 0.000 | 0.000 |
| 00012 | 7.226 | −18.214 | −0.510 | 1.010 | −17.940 | 18.039 | 32.483 | −1.235 | 20.000 | 0.000 | 0.000 |
| 00013 | −26.544 | −18.846 | −0.510 | 2.590 | −16.985 | 18.039 | 31.845 | −1.235 | 20.000 | 0.000 | 0.000 |
| 00014 | 409.598 | −18.530 | −0.510 | 5.751 | −12.528 | 19.935 | 31.526 | −1.235 | 20.000 | 0.000 | 0.000 |
| 00015 | 667.651 | −18.846 | 0.127 | 7.332 | −12.209 | 20.251 | 30.889 | −2.183 | 20.000 | 0.000 | 0.000 |
| 00016 | 498.482 | −19.478 | −0.510 | 8.596 | −12.528 | 19.935 | 30.889 | −1.867 | 20.000 | 0.000 | 0.000 |
| 00017 | 360.217 | −18.530 | 0.446 | 6.700 | −12.846 | 20.566 | 32.164 | −2.183 | 20.000 | 0.000 | 0.000 |
| 00018 | 141.987 | −18.846 | −0.192 | 5.751 | −12.846 | 20.566 | 30.889 | −1.235 | 20.000 | 0.000 | 0.000 |
| 00019 | −78.792 | −19.162 | 0.127 | 6.068 | −11.254 | 20.251 | 31.526 | −1.867 | 20.000 | 0.000 | 0.000 |
| 00020 | −280.137 | −18.530 | −0.510 | 5.435 | −12.528 | 20.566 | 31.207 | −1.867 | 20.000 | 0.000 | 0.000 |
| 00021 | −423.818 | −18.530 | −0.192 | 2.590 | −14.756 | 19.303 | 32.164 | −0.919 | 20.000 | 0.000 | 0.000 |
| 00022 | −535.960 | −17.582 | −0.192 | 1.958 | −15.074 | 19.935 | 31.845 | −0.919 | 20.000 | 0.000 | 0.000 |
| 00023 | −599.995 | −16.950 | −0.829 | 1.010 | −16.030 | 19.619 | 33.758 | −0.602 | 20.000 | 0.000 | 0.000 |
| 00024 | −594.579 | −16.950 | −0.192 | −1.519 | −19.213 | 18.671 | 32.164 | −0.602 | 20.000 | 0.000 | 0.000 |
| 00025 | −558.579 | −15.686 | −0.192 | −1.835 | −20.805 | 17.723 | 33.120 | −1.235 | 20.000 | 0.000 | 0.000 |
| 00026 | −485.623 | −16.634 | −0.192 | −2.783 | −21.760 | 17.723 | 33.439 | −1.235 | 20.000 | 0.000 | 0.000 |
| 00027 | −366.792 | −17.266 | −0.192 | −1.835 | −23.033 | 17.408 | 32.483 | −0.602 | 20.000 | 0.000 | 0.000 |
| 00028 | −213.871 | −16.318 | 0.127 | −1.835 | −23.033 | 16.144 | 31.207 | −1.551 | 20.000 | 0.000 | 0.000 |
| 00029 | −30.686 | −16.318 | −0.510 | −1.519 | −25.262 | 16.460 | 34.077 | −0.602 | 20.000 | 0.000 | 0.000 |
| | | [ms] | Jest | Rot | Tacc | Toob | mgrest | Toob(Rot) | OreAngle | Tumble | r d t |
| | | 00000 | 0.000 | 0.000 | 0.000 | 0.000 | 0.000 | 0.000 | 0.000 | 0.000 | 0 0 0 |
| | | 00001 | 0.000 | 0.000 | 0.000 | 0.000 | 0.000 | 0.000 | 0.000 | 0.000 | 0 0 0 |
| | | 00002 | 0.000 | 0.000 | 0.000 | 0.000 | 0.000 | 0.000 | 0.000 | 0.000 | 0 0 0 |
| | | 00003 | 0.000 | 0.000 | 0.000 | 0.000 | 0.000 | 0.000 | 0.000 | 0.000 | 0 0 0 |
| | | 00004 | 0.000 | 0.000 | 0.000 | 0.000 | 0.000 | 0.000 | 0.000 | 0.000 | 0 0 0 |
| | | 00005 | 0.000 | 0.000 | 0.000 | 0.000 | 0.000 | 0.000 | 0.000 | 0.000 | 0 0 0 |
| | | 00006 | 0.000 | 0.000 | 0.000 | 0.000 | 0.000 | 0.000 | 0.000 | 0.000 | 0 0 0 |
| | | 00007 | 0.000 | 0.000 | 0.000 | 0.000 | 0.000 | 0.000 | 0.000 | 0.000 | 0 0 0 |
| | | 00008 | 0.000 | 0.000 | 0.000 | 0.000 | 0.000 | 0.000 | 0.000 | 0.000 | 0 0 0 |
| | | 00009 | 0.000 | 0.000 | 0.000 | 0.000 | 0.000 | 0.000 | 0.000 | 0.000 | 0 0 0 |
| | | 00010 | 0.000 | 0.000 | 0.000 | 0.000 | 0.000 | 0.000 | 0.000 | 0.000 | 0 0 0 |
| | | 00011 | 0.000 | 0.000 | 0.000 | 0.000 | 0.000 | 0.000 | 0.000 | 0.000 | 0 0 0 |
| | | 00012 | 0.000 | 0.000 | 0.000 | 0.000 | 0.000 | 0.000 | 0.000 | 0.000 | 0 0 0 |
| | | 00013 | 0.000 | 0.000 | 0.000 | 0.000 | 0.000 | 0.000 | 0.000 | 0.000 | 0 0 0 |
| | | 00014 | 0.000 | 0.000 | 0.000 | 0.000 | 0.000 | 0.000 | 0.000 | 0.000 | 0 0 0 |
| | | 00015 | 0.000 | 0.000 | 0.000 | 0.000 | 0.000 | 0.000 | 0.000 | 0.000 | 0 0 0 |
| | | 00016 | 0.000 | 0.000 | 0.000 | 0.000 | 0.000 | 0.000 | 0.000 | 0.000 | 0 0 0 |
| | | 00017 | 0.000 | 0.000 | 0.000 | 0.000 | 0.000 | 0.000 | 0.000 | 0.000 | 0 0 0 |
| | | 00018 | 0.000 | 0.000 | 0.000 | 0.000 | 0.000 | 0.000 | 0.000 | 0.000 | 0 0 0 |
| | | 00019 | 0.000 | 0.000 | 0.000 | 0.000 | 0.000 | 0.000 | 0.000 | 0.000 | 0 0 0 |
| | | 00020 | NaN | 0.000 | 0.000 | 0.000 | 0.000 | 0.000 | 0.000 | 0.000 | 1 0 0 |
| | | 00021 | NaN | 0.000 | 0.000 | 0.000 | 0.000 | 0.000 | 0.000 | 0.000 | 1 0 0 |
| | | 00022 | NaN | 0.000 | 0.000 | 0.000 | 0.000 | 0.000 | 0.000 | 0.000 | 1 0 0 |
| | | 00023 | NaN | 0.000 | 0.000 | 0.000 | 0.000 | 0.000 | 0.000 | 0.000 | 1 0 0 |
| | | 00024 | NaN | 0.000 | 0.000 | 0.000 | 0.000 | 0.000 | 0.000 | 0.000 | 1 0 0 |
| | | 00025 | NaN | 0.000 | 0.000 | 0.000 | 0.000 | 0.000 | 0.000 | 0.000 | 1 0 0 |
| | | 00026 | NaN | 0.000 | 0.000 | 0.000 | 0.000 | 0.000 | 0.000 | 0.000 | 1 0 0 |
| | | 00027 | NaN | 0.000 | 0.000 | 0.000 | 0.000 | 0.000 | 0.000 | 0.000 | 1 0 0 |
| | | 00028 | NaN | 0.000 | 0.000 | 0.000 | 0.000 | 0.000 | 0.000 | 0.000 | 1 0 0 |
| | | 00029 | NaN | 0.000 | 0.000 | 0.000 | 0.000 | 0.000 | 0.000 | 0.000 | 1 0 0 |

The recording includes some pre-trigger values. It can be seen that only at t−12 ms the motor is started, and there the current is only 7.2 A. Al calculated values are still zero.
Values around 1° of mill rotation. (Estimation of J is finalized at this point, and therefore calculation of Tacc and Toob may begin. At this stage the angle of repose θ cannot yet be calculated from mgr sin θ because mgr is not known yet, and is set equal to mill rotation Rot=φ by the DCPR)

| [ms] | Ir1 | Iw1 | Ib1 | Vpp1 | Ir2 | Iw2 | Ib2 | Vpp2 | T | n | \|I\| |
|---|---|---|---|---|---|---|---|---|---|---|---|
| 00867 | −542.650 | −16.950 | 0.446 | −2.151 | −23.033 | 15.196 | 32.164 | −1.867 | 21.221 | 42.705 | 456.347 |
| 00868 | −613.694 | −16.950 | 0.127 | −2.783 | −23.988 | 15.196 | 32.164 | −1.867 | 21.221 | 42.769 | 456.438 |
| 00869 | −650.013 | −16.950 | 0.127 | −1.519 | −22.397 | 15.828 | 32.164 | −2.183 | 21.221 | 42.832 | 456.528 |
| 00870 | −620.385 | −16.318 | 0.127 | −2.151 | −21.442 | 17.092 | 33.439 | −0.919 | 21.221 | 42.895 | 456.618 |
| 00871 | −530.544 | −15.686 | −0.192 | −0.887 | −19.850 | 18.355 | 34.077 | −1.235 | 21.221 | 42.958 | 456.707 |
| 00872 | −403.110 | −17.582 | 1.083 | 0.694 | −16.985 | 19.619 | 32.483 | −1.867 | 21.221 | 43.022 | 456.796 |
| 00873 | −214.508 | −17.266 | −0.192 | 1.326 | −15.393 | 20.882 | 32.801 | −1.867 | 21.221 | 43.085 | 456.884 |
| 00874 | −20.491 | −17.898 | 0.127 | 1.010 | −14.438 | 20.251 | 32.801 | −0.602 | 21.221 | 43.148 | 456.972 |
| 00875 | 129.562 | −19.478 | −0.192 | 4.487 | −12.209 | 22.146 | 33.120 | −0.919 | 21.221 | 43.210 | 457.060 |
| 00876 | 317.208 | −19.478 | −0.192 | 6.384 | −11.573 | 21.198 | 31.845 | −1.235 | 21.221 | 43.273 | 457.147 |
| 00877 | 485.421 | −19.162 | 0.127 | 6.700 | −12.528 | 21.514 | 32.164 | −1.551 | 21.221 | 43.336 | 457.233 |
| 00878 | 576.217 | −19.162 | −0.192 | 6.384 | −15.074 | 20.566 | 31.207 | −2.499 | 21.221 | 43.399 | 457.319 |
| 00879 | 631.969 | −18.530 | −0.510 | 5.435 | −17.303 | 19.935 | 31.845 | −0.919 | 21.221 | 43.461 | 457.404 |
| 00880 | 632.606 | −17.582 | 0.127 | 4.803 | −17.303 | 19.303 | 31.526 | −0.919 | 21.221 | 43.524 | 457.489 |
| 00881 | 563.474 | −18.846 | −0.510 | 4.803 | −17.621 | 18.671 | 30.889 | −1.551 | 21.221 | 43.586 | 457.573 |
| 00882 | 458.978 | −17.898 | 0.764 | 2.274 | −19.213 | 15.828 | 30.570 | −1.235 | 21.221 | 43.649 | 457.657 |
| | | [ms] | Jest | Rot | Tacc | Toob | mgrest | Toob(Rot) | OreAngle | Tumble | r d t |
| | | 00867 | 2013.124 | 0.988 | 0.000 | 0.000 | 0.000 | 0.000 | 0.988 | 0.000 | 1 0 0 |
| | | 00868 | 2013.364 | 0.991 | 0.000 | 0.000 | 0.000 | 0.000 | 0.991 | 0.000 | 1 0 0 |
| | | 00869 | 2013.608 | 0.994 | 0.000 | 0.000 | 0.000 | 0.000 | 0.994 | 0.000 | 1 0 0 |
| | | 00870 | 2013.855 | 0.998 | 0.000 | 0.000 | 0.000 | 0.000 | 0.998 | 0.000 | 1 0 0 |
| | | 00871 | 2014.106 | 1.001 | 0.000 | 0.000 | 0.000 | 0.000 | 1.001 | 0.000 | 1 0 0 |
| | | 00872 | 2014.106 | 1.004 | 0.000 | 0.000 | 0.000 | 0.000 | 1.004 | 0.000 | 1 0 0 |
| | | 00873 | 2014.106 | 1.007 | 0.000 | 0.000 | 0.000 | 0.000 | 1.007 | 0.000 | 1 0 0 |
| | | 00874 | 2014.106 | 1.010 | 13288.542 | 1172.806 | 66541.078 | 0.000 | 1.010 | 0.000 | 1 0 0 |
| | | 00875 | 2014.106 | 1.013 | 13274.087 | 1190.028 | 67310.973 | 0.000 | 1.013 | 0.000 | 1 0 0 |
| | | 00876 | 2014.106 | 1.016 | 13259.818 | 1207.049 | 68064.526 | 0.000 | 1.016 | 0.000 | 1 0 0 |
| | | 00877 | 2014.106 | 1.019 | 13245.741 | 1223.861 | 68801.393 | 0.000 | 1.019 | 0.000 | 1 0 0 |
| | | 00878 | 2014.106 | 1.022 | 13231.865 | 1240.455 | 69521.268 | 0.000 | 1.022 | 0.000 | 1 0 0 |
| | | 00879 | 2014.106 | 1.025 | 13218.196 | 1256.824 | 70223.882 | 0.000 | 1.025 | 0.000 | 1 0 0 |
| | | 00880 | 2014.106 | 1.029 | 13204.740 | 1272.962 | 70909.004 | 0.000 | 1.029 | 0.000 | 1 0 0 |
| | | 00881 | 2014.106 | 1.032 | 13191.505 | 1288.861 | 71576.439 | 0.000 | 1.032 | 0.000 | 1 0 0 |
| | | 00882 | 2014.106 | 1.035 | 13178.494 | 1304.517 | 72226.026 | 0.000 | 1.035 | 0.000 | 1 0 0 |

Values around 10° of mill rotation. (Estimation of mgr is finilized at this point, and therefore calculation of θ may now start independently from φ.)

| [ms] | Ir1 | Iw1 | Ib1 | Vpp1 | Ir2 | Iw2 | Ib2 | Vpp2 | T | n | \|I\| |
|---|---|---|---|---|---|---|---|---|---|---|---|
| 02367 | −665.942 | −16.950 | −0.510 | 0.378 | −16.030 | 19.935 | 32.483 | −1.867 | 22.731 | 116.487 | 629.222 |
| 02368 | −806.438 | −16.634 | 0.127 | −1.519 | −17.621 | 19.935 | 32.483 | −0.919 | 22.731 | 116.512 | 629.255 |
| 02369 | −899.464 | −15.686 | −0.510 | −2.783 | −18.576 | 19.935 | 34.077 | −0.919 | 22.731 | 116.536 | 629.289 |
| 02370 | −907.747 | −16.318 | −0.192 | −2.783 | −19.531 | 19.303 | 32.164 | −1.551 | 22.731 | 116.561 | 629.323 |
| 02371 | −857.411 | −17.266 | 0.127 | −0.887 | −19.850 | 18.355 | 32.164 | −1.867 | 22.731 | 116.585 | 629.356 |
| 02372 | −742.721 | −16.634 | −0.510 | −2.467 | −23.670 | 17.723 | 32.164 | −1.235 | 22.731 | 116.609 | 629.390 |
| 02373 | −545.836 | −16.318 | −0.192 | −1.519 | −23.988 | 17.723 | 32.483 | −2.183 | 22.731 | 116.634 | 629.423 |
| 02374 | −353.093 | −16.002 | −0.192 | -0.571 | −23.033 | 17.408 | 32.801 | −2.499 | 22.731 | 116.658 | 629.456 |
| 02375 | −123.712 | −17.582 | −0.829 | 0.378 | −20.805 | 17.408 | 31.207 | −1.867 | 22.731 | 116.682 | 629.489 |
| 02376 | 154.730 | −17.266 | −0.192 | 0.694 | −21.442 | 16.460 | 30.570 | −2.499 | 22.731 | 116.707 | 629.522 |
| 02377 | 386.660 | −16.950 | −0.829 | 1.642 | −19.850 | 17.092 | 31.526 | −2.499 | 22.731 | 116.731 | 629.555 |
| 02378 | 584.182 | −18.214 | −0.510 | 4.803 | −18.258 | 18.039 | 30.570 | −1.867 | 22.731 | 116.755 | 629.588 |
| 02379 | 754.305 | −18.530 | 0.446 | 7.016 | −14.119 | 18.039 | 29.295 | −2.183 | 22.731 | 116.779 | 629.620 |
| 02380 | 855.615 | −18.530 | −0.510 | 8.280 | −12.528 | 20.882 | 31.207 | −1.867 | 22.731 | 116.803 | 629.653 |
| 02381 | 891.615 | −17.582 | −0.510 | 5.435 | −12.846 | 20.251 | 31.207 | −2.499 | 22.731 | 116.827 | 629.685 |
| 02382 | 870.270 | −17.898 | −0.510 | 5.435 | −11.254 | 20.566 | 30.251 | −1.867 | 22.731 | 116.851 | 629.717 |
| 02383 | 765.137 | −18.530 | −0.510 | 6.700 | −11.891 | 21.830 | 31.207 | −1.551 | 22.731 | 116.875 | 629.749 |
| 02384 | 598.836 | −17.898 | −0.829 | 5.119 | −12.846 | 22.462 | 31.207 | −1.867 | 22.731 | 116.899 | 629.781 |
| 02385 | 400.677 | −17.898 | −0.192 | 1.958 | −14.119 | 20.566 | 30.889 | −0.602 | 22.731 | 116.923 | 629.813 |
| 02386 | 167.474 | −17.266 | −0.829 | 1.642 | −15.711 | 19.935 | 32.164 | −1.551 | 22.731 | 116.947 | 629.844 |
| 02387 | −76.562 | −16.634 | −0.829 | 1.010 | −17.940 | 18.987 | 31.845 | −0.919 | 22.716 | 116.971 | 629.876 |
| 02388 | −318.048 | −16.634 | 0.127 | −1.519 | −20.805 | 18.671 | 31.845 | −1.235 | 22.716 | 116.995 | 629.907 |
| | | [ms] | Jest | Rot | Tacc | boob | mgrest | Toob(Rot) | OreAngle | Tumble | r d t |
| | | 02367 | 2014.106 | 9.970 | 5174.507 | 14737.837 | 85121.016 | 0.000 | 9.970 | 0.000 | 1 0 0 |
| | | 02368 | 2014.106 | 9.979 | 5168.315 | 14745.100 | 85092.049 | 0.000 | 9.979 | 0.000 | 1 0 0 |
| | | 02369 | 2014.106 | 9.987 | 5162.071 | 14752.412 | 85063.399 | 0.000 | 9.987 | 0.000 | 1 0 0 |
| | | 02370 | 2014.106 | 9.996 | 5155.771 | 14759.776 | 85035.081 | 0.000 | 9.996 | 0.000 | 1 0 0 |
| | | 02371 | 2014.106 | 10.004 | 5149.414 | 14767.193 | 85007.107 | 0.000 | 10.004 | 0.000 | 1 0 0 |
| | | 02372 | 2014.106 | 10.012 | 5149.414 | 14768.250 | 85007.107 | 14779.468 | 10.005 | 0.008 | 1 0 0 |
| | | 02373 | 2014.106 | 10.021 | 5149.414 | 14769.303 | 85007.107 | 14791.746 | 10.005 | 0.015 | 1 0 0 |
| | | 02374 | 2014.106 | 10.029 | 5129.974 | 14789.793 | 85007.107 | 14804.026 | 10.019 | 0.010 | 1 0 0 |
| | | 02375 | 2014.106 | 10.038 | 5123.362 | 14797.450 | 85007.107 | 14816.308 | 10.025 | 0.013 | 1 0 0 |
| | | 02376 | 2014.106 | 10.046 | 5116.681 | 14805.174 | 85007.107 | 14828.592 | 10.030 | 0.016 | 1 0 0 |
| | | 02377 | 2014.106 | 10.054 | 5109.928 | 14812.965 | 85007.107 | 14840.878 | 10.035 | 0.019 | 1 0 0 |
| | | 02378 | 2014.106 | 10.063 | 5103.101 | 14820.827 | 85007.107 | 14853.167 | 10.041 | 0.022 | 1 0 0 |
| | | 02379 | 2014.106 | 10.071 | 5096.197 | 14828.761 | 85007.107 | 14865.458 | 10.046 | 0.025 | 1 0 0 |
| | | 02380 | 2014.106 | 10.080 | 5089.213 | 14836.771 | 85007.107 | 14877.751 | 10.052 | 0.028 | 1 0 0 |
| | | 02381 | 2014.106 | 10.088 | 5082.149 | 14844.858 | 85007.107 | 14890.046 | 10.057 | 0.031 | 1 0 0 |
| | | 02382 | 2014.106 | 10.097 | 5075.001 | 14853.024 | 85007.107 | 14902.344 | 10.063 | 0.034 | 1 0 0 |
| | | 02383 | 2014.106 | 10.105 | 5067.767 | 14861.272 | 85007.107 | 14914.644 | 10.068 | 0.037 | 1 0 0 |
| | | 02384 | 2014.106 | 10.113 | 5060.445 | 14869.603 | 85007.107 | 14926.946 | 10.074 | 0.039 | 1 0 0 |
| | | 02385 | 2014.106 | 10.122 | 5053.033 | 14878.020 | 85007.107 | 14939.250 | 10.080 | 0.042 | 1 0 0 |
| | | 02386 | 2014.106 | 10.130 | 5045.529 | 14886.526 | 85007.107 | 14951.556 | 10.086 | 0.045 | 1 0 0 |
| | | 02387 | 2014.106 | 10.139 | 5037.930 | 14895.121 | 85007.107 | 14963.865 | 10.092 | 0.047 | 1 0 0 |
| | | 02388 | 2014.106 | 10.147 | 5030.234 | 14903.808 | 85007.107 | 14976.175 | 10.098 | 0.050 | 1 0 0 |

Values around 12 s. By this time the values of θ and φ have diverged dramatically, θ still being safely below 30° while the mill shell has already rotated almost 60°.

| [ms] | Ir1 | Iw1 | Ib1 | Vpp1 | Ir2 | Iw2 | Ib2 | Vpp2 | T | n | \|I\| |
|---|---|---|---|---|---|---|---|---|---|---|---|
| 11990 | −1311.075 | −16.318 | 0.127 | −1.835 | −17.621 | 18.987 | 34.077 | −1.867 | 26.203 | 213.763 | 1831.718 |
| 11991 | −728.703 | −17.582 | −0.192 | −0.571 | −16.030 | 19.619 | 34.395 | −1.867 | 26.203 | 213.863 | 1831.856 |
| 11992 | −89.305 | −16.634 | 0.446 | 0.378 | −15.711 | 19.303 | 33.758 | −1.867 | 26.203 | 213.962 | 1831.994 |
| 11993 | 542.129 | −17.266 | 1.083 | 1.642 | −16.030 | 19.619 | 33.439 | −1.867 | 26.203 | 214.062 | 1832.132 |
| 11994 | 1146.164 | −17.898 | 0.127 | 2.906 | −15.074 | 20.882 | 34.077 | −2.499 | 26.203 | 214.161 | 1832.270 |
| 11995 | 1704.004 | −18.846 | 0.446 | 3.855 | −16.030 | 18.355 | 31.845 | −2.815 | 26.203 | 214.260 | 1832.408 |
| 11996 | 2128.358 | −18.846 | 0.127 | 6.068 | −15.711 | 18.671 | 32.164 | −2.499 | 26.203 | 214.360 | 1832.546 |
| 11997 | 2440.571 | −19.478 | 0.127 | 7.016 | −16.348 | 18.987 | 32.164 | −2.499 | 26.203 | 214.459 | 1832.684 |
| 11998 | 2621.845 | −17.266 | 0.127 | 3.855 | −15.074 | 19.303 | 33.439 | −1.867 | 26.203 | 214.559 | 1832.822 |
| 11999 | 2640.960 | −17.266 | 0.127 | 4.803 | −16.348 | 18.987 | 33.439 | −1.551 | 26.203 | 214.658 | 1832.960 |
| 12000 | 2510.022 | −19.162 | 0.127 | 4.487 | −16.348 | 18.039 | 32.483 | −2.815 | 26.203 | 214.758 | 1833.098 |
| 12001 | 2225.526 | −17.898 | 0.127 | 2.274 | −18.576 | 17.723 | 32.801 | −3.448 | 26.203 | 214.857 | 1833.235 |
| 12002 | 1833.987 | −16.950 | −0.192 | 1.326 | −19.213 | 17.092 | 33.439 | −2.815 | 26.203 | 214.957 | 1833.373 |
| 12003 | 1347.190 | −17.266 | 0.127 | 0.694 | −20.168 | 17.092 | 32.483 | −2.499 | 26.203 | 215.057 | 1833.510 |
| 12004 | 768.323 | −16.318 | 0.764 | −2.151 | −22.397 | 15.828 | 33.439 | −2.499 | 26.203 | 215.156 | 1833.648 |
| | | [ms] | Jest | Rot | Tacc | Toob | mgrest | Toob(Rot) | OreAngle | Tumble | r d t |
| | | 11990 | 2014.106 | 58.434 | 20944.536 | 37021.999 | 85007.107 | 72429.453 | 25.818 | 32.616 | 1 1 1 |
| | | 11991 | 2014.106 | 58.450 | 20948.866 | 37022.042 | 85007.107 | 72441.414 | 25.818 | 32.631 | 1 1 1 |
| | | 11992 | 2014.106 | 58.465 | 20953.245 | 37022.036 | 85007.107 | 72453.376 | 25.818 | 32.647 | 1 1 1 |
| | | 11993 | 2014.106 | 58.480 | 20957.680 | 37021.972 | 85007.107 | 72465.338 | 25.818 | 32.662 | 1 1 1 |
| | | 11994 | 2014.106 | 58.496 | 20962.177 | 37021.844 | 85007.107 | 72477.300 | 25.818 | 32.678 | 1 1 1 |
| | | 11995 | 2014.106 | 58.511 | 20966.744 | 37021.646 | 85007.107 | 72489.263 | 25.818 | 32.693 | 1 1 1 |
| | | 11996 | 2014.106 | 58.527 | 20971.386 | 37021.372 | 85007.107 | 72501.226 | 25.818 | 32.709 | 1 1 1 |
| | | 11997 | 2014.106 | 58.542 | 20976.106 | 37021.017 | 85007.107 | 72513.189 | 25.817 | 32.725 | 1 1 1 |
| | | 11998 | 2014.106 | 58.558 | 20980.910 | 37020.577 | 85007.107 | 72525.153 | 25.817 | 32.741 | 1 1 1 |
| | | 11999 | 2014.106 | 58.573 | 20985.799 | 37020.049 | 85007.107 | 72537.116 | 25.817 | 32.756 | 1 1 1 |
| | | 12000 | 2014.106 | 58.589 | 20990.778 | 37019.430 | 85007.107 | 72549.080 | 25.816 | 32.772 | 1 1 1 |
| | | 12001 | 2014.106 | 58.604 | 20995.847 | 37018.719 | 85007.107 | 72561.045 | 25.816 | 32.788 | 1 1 1 |
| | | 12002 | 2014.106 | 58.620 | 21001.007 | 37017.914 | 85007.107 | 72573.009 | 25.815 | 32.804 | 1 1 1 |
| | | 12003 | 2014.106 | 58.635 | 21006.260 | 37017.014 | 85007.107 | 72584.974 | 25.814 | 32.821 | 1 1 1 |
| | | 12004 | 2014.106 | 58.651 | 21011.604 | 37016.018 | 85007.107 | 72596.939 | 25.814 | 32.837 | 1 1 1 |

Tumbling has occurred when φ is no longer equal to θ, and this may be used as a criterion to determine if start-up of the mill has been safe and successful.

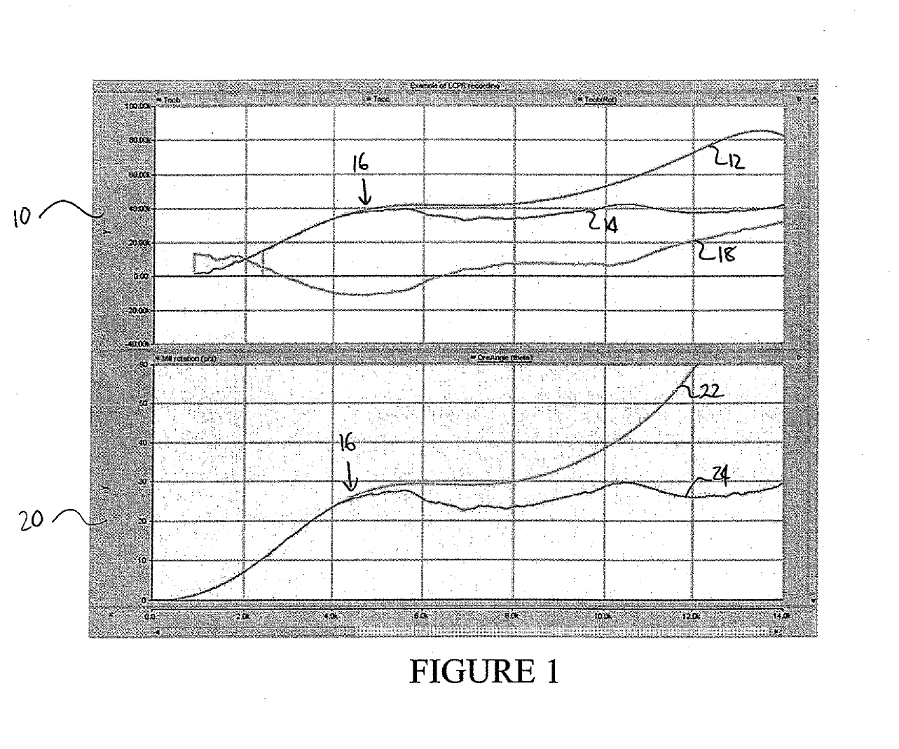

In FIG. 1, line 12 on graph 10 is representative of the result of the calculation mgr sin θ and line 14 is representative of the result of the calculation mgr sin θ. Tumbling of the charge has occurred at the point in time marked 16. Line 18 represents the result of the formula Jα.

Graph 20 in FIG. 1 shows the plotted angle φ 22 and the plotted angle θ 24.

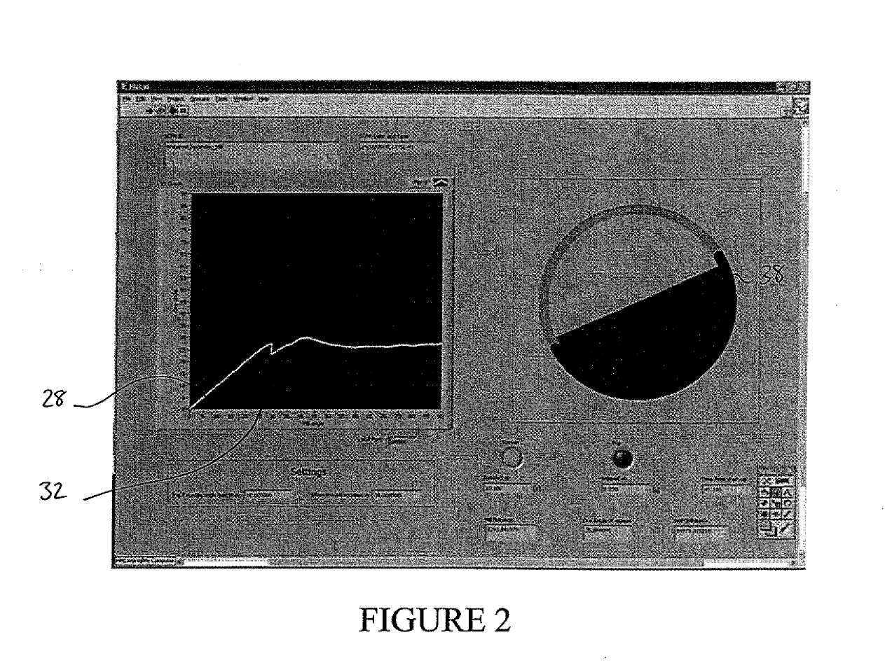

In the screenshot shown in FIG. 2 the graph 28 depicts the graphical representation of the charge's angle of repose (θ) relative the mill shell's angle of rotation (φ). It can be seen that the angle θ relative the angle φ is a 45° line before tumbling occurs. The drop in the graph 32 denotes the angle of φ at which at which tumbling has occurred.

The graphic representation 34 shows θ36 and φ 38 in a simulated mill shell.

1. A dropped charge protection system, wherein the system includes calculating an angle of repose of a charge of a grinding mill during start-up and tripping the mill motor when the angle of repose of the charge exceeds a maximum allowable angle, thereby assisting in preventing damage occurring to the grinding mill from a charge that has frozen that does not tumble with rotation of the grinding mill.

2. A dropped charge protection system as claimed in claim 1, wherein the system includes plotting the calculated angle of repose relative an angle of rotation of the mill shell and wherein the angle of repose (θ) of the charge is determined by solving the non-linear differential equation of T=Jα mgr sin/and wherein;
T is the air-gap torque applied to the motor rotor by the electric field referenced to the mill shell side of the drive train;
q is the angular acceleration of the mill around the centre of rotation of the mill shell and is determined from d/dt(ω);
w is the angular speed of the mill shell around the centre of rotation of the mill shell and is determined from d/dt(φ));
J is the moment of inertia [kgm²] of all the rotating mass referenced to the mill shell side of the drive train;
m is the mass of the charge;
g is the gravitational constant; and
r is the radius from the mill shell's axis of rotation to the centre of gravity of the charge.

3-4. (canceled)

5. A dropped charge protection system as claimed claim 2, wherein θ=φ before the charge has tumbled and wherein φ is the angular position of the mill shell around the centre of rotation of the mill shell and wherein the angle of repose 0 is a tripping criterion.

6-7. (canceled)

8. A dropped charge protection system as claimed in claim 2, wherein solving θ, includes determining the system parameters J and mgr and the system variables T and α, measured in real time and/or calculated from measurable quantities in real time.

9. (canceled)

10. A dropped charge protection system as claimed in claim 2, wherein any one or more of θ and/or α and/or ω is measured through the use of rotary' encoders, magnetic pick-ups and the like on the motor shaft or elsewhere in the drive train.

11. A dropped charge protection system as claimed in claim 2, wherein T and any one or more of φ and/or α and/or ω are calculated from the rotor current of the mill motor in real time, making both the instantaneous measurement of power of the motor and the use of rotary encoders, magnetic pick-ups and the like on the motor shaft or elsewhere in the drive train unnecessary, in the case of a wound-rotor motor and if the rotor current is accessible.

12. (canceled)

13. A dropped charge protection system as claimed in claim 1, wherein the mill motor includes a liquid resistance starter (LRS) in series with the motor rotor windings.

14. A dropped charge protection system as claimed in claim 13, wherein the LRS controls the rotor current and thereby controls the amount of torque produced by the motor as the torque is proportional to the rotor current.

15-21. (canceled)

22. A dropped charge protection system as claimed in claim 2, wherein J and mgr are determined dynamically within the first few degrees of mill rotation, before the possibility of a dropped charge exists, thereby facilitating the timeous calculation of θ.

23-28. (canceled)

29. A dropped charge protection system as claimed in claim 2, wherein θ is calculated once J and mgr have been calculated, φ is plotted relative an angle of rotation of the mill shell (4)) thereby tripping the mill motor when the angle of repose of the charge exceeds a maximum allowable angle.

30. A dropped charge protection system as claimed in claim 2, wherein J and mgr are dependent on r but r is not readily determinable due to the non-homogenous state of the charge.

31. (canceled)

32. A dropped charge protection system as claimed in claim 1, wherein the system includes a control system for controlling the torque applied to starting a grinding mill by means of controlling the liquid resistance, the control system using a pre-determined angle of repose, controlling a real angle of repose of a charge such that the real angle of repose coincides with the pre-determined angle of repose through the manipulation of the torque of the motor and wherein the angle of repose is controlled in such a way as to encourage tumbling of the charge.

33. A control system as claimed in claim 32, wherein the torque is an actuating signal and the angle of repose θ is the controlled signal.

34. A control system as claimed in claim 32 wherein the angle of repose of the charge is determined by solving the non-linear differential equation of T=Jα+mgr sin θ wherein T is the air-gap torque applied to the motor rotor by the electric field referenced to the mill shell side of the drive train, J is the moment of inertia [kgm²] of all the rotating mass referenced to the mill side of the drive train, m is the mass of the charge, g is the gravitational constant, r is the radius from the mill's axis of rotation to the centre of gravity of the charge, and θ is the rotation of the centre of gravity of the charge around the mill's axis of rotation which was defined above as the angle of repose.

35. (canceled)

36. A control system as claimed in claim 32, wherein prior to the tumbling of the charge; the charge rotates with the mill and θ=φ, and wherein φ is the angular position of the mill around the centre of rotation of the mill shell.

37-38. (canceled)

39. A control system as claimed in claim 32, wherein solving θ, requires the determining of the system parameters J and mgr and the system variables. T and α, measured in real time and/or calculated from measurable quantities in real time.

40-52. (canceled)

53. A control system as claimed in claim 32, wherein J and mgr are determined dynamically within the first few degrees of mill rotation, before the possibility of a dropped charge exists, thereby facilitating the timeous calculation of θ.

54-58. (canceled)

59. A control system as claimed in claim 12, wherein the calculation of mgr permits the calculation of the amount of torque (T) necessary to keep φ at an optimum angle for the charge to tumble.

60. A control system as claimed in claim 12, wherein controlling the liquid resistance starter, permits the rotor current to be controlled, thereby to apply the correct amount of torque to bring φ to this optimum angle.
